(19) United States
(12) Patent Application Publication
(10) Pub. No.: US 2009/0225400 A1
(43) Pub. Date: Sep. 10, 2009

(54) ILLUMINATION SYSTEM

(75) Inventors: Johannes Petrus Maria Ansems, Eindhoven (NL); Christoph Gerard August Hoelen, Eindhoven (NL)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS N.V., EINDHOVEN (NL)

(21) Appl. No.: 11/721,091

(22) PCT Filed: Dec. 2, 2005
(86) PCT No.: PCT/IB05/54014

§ 371 Date: Jun. 7, 2007

(30) Foreign Application Priority Data
Dec. 9, 2004 (EP) 04106434.6

(51) Int. Cl. G02F 1/29

(52) U.S. Cl. 359/315

(57) ABSTRACT

An illumination system has a plurality of light emitters (R, G, B) and a light-collimator (1) for collimating light emitted by the light emitters. The light-collimator is arranged around a longitudinal axis (25) of the illumination system. A light-exit window (5) of the light-collimator at a side facing away from the light-emitters is provided with a translucent cover plate (11) provided with a switchable optical element (15) based on electro wetting. The light-exit window of the light-collimator or the translucent cover plate is provided with a light-dispersing structure (7) for broadening an angular distribution of the light emitted by the illumination system. The optical element (15) being switchable in a mode of operation reducing the effect of the light-dispersing structure (7). Preferably, the effect of the light-dispersing structure is substantially counteracted when the switchable optical element operates in the mode of operation reducing the effect of the light-dispersing structure.

The invention relates to an illumination system comprising a plurality of light emitters, a light-collimator for collimating light emitted by the light emitters, and a light-dispersing structure for broadening an angular distribution of the light emitted by the illumination system.

Such illumination systems are known per se. They are used, inter alia, for general lighting purposes, such as spot lights, accent lighting, flood lights and for large-area direct-view light emitting panels such as applied, for instance, in signage, contour lighting, and billboards. In other applications, the light emitted by such illumination systems is fed into a light guide, optical fiber or other beam-shaping optics. In addition, such illumination systems are used as backlighting of (image) display devices, for example for television receivers and monitors. Such illumination systems can be used as a backlight for non-emissive displays, such as liquid crystal display devices, also referred to as LCD panels, which are used in (portable) computers or (cordless) telephones. Another application area of the illumination system according to the invention is the use as illumination source in a digital projector or so-called beamer for projecting images or displaying a television program, a film, a video program or a DVD, or the like.

Generally, such illumination systems comprise a multiplicity of light sources, for instance light-emitting diodes (LEDs). LEDs can be light sources of distinct primary colors, such as, for example the well-known red (R), green (G), or blue (B) light emitters. In addition, the light emitter can have, for example, amber or cyan as primary color. These primary colors may be either generated directly by the light-emitting-diode chip, or may be generated by a phosphor upon irradiance with light from the light-emitting-diode chip. In the latter case, also mixed colors or white light is possible as one of the primary colors. Generally, the light emitted by the light sources is mixed in the light-collimator for obtaining a uniform distribution of the light while eliminating the correlation of the light emitted by the illumination system to a specific light source. In addition, it is known to employ a controller with a sensor and some feedback algorithm in order to obtain high color accuracy.

US Patent Application US-A 2003/0 193 807 discloses a LED-based elevated omni-directional airfield light. The known illumination system comprises a LED light source, a light transformer, a hemispherical optical window, a circuit and a base. The light transformer includes a truncated hollow conical reflector, a curved reflective surface, and an optical element. A light shaping diffuser, particularly a holographic diffuser, may be used as dispersing optical element. The conical reflector has a truncated end facing the light source and a cone base opposite the truncated end. The conical reflector axis is coincident with a light source axis, and light passes through an opening on the truncated end. The curved reflective surface is between the truncated end and the cone base. The surface reflects light from the light source in a limited angle omni-directional pattern with a pre-determined intensity distribution. The optical element is adjacent the cone base in a plane perpendicular to the conical reflector axis, and disperses the light passing through the truncated hollow cone reflector.

A drawback of the known illumination system is that the beam pattern emitted by the illumination system cannot be changed.

The invention has for its object to eliminate the above disadvantage wholly or partly. According to the invention, this object is achieved by an illumination system comprising:

a plurality of light emitters,

a light-collimator for collimating light emitted by the light emitters,

the light-collimator being arranged around a longitudinal axis of the illumination system,

a light-exit window of the light-collimator at a side facing away from the light-emitters being provided with a translucent cover plate provided with a switchable optical element based on electrowetting,

the light-exit window of the light-collimator or the translucent cover plate being provided with a light-dispersing structure for broadening an angular distribution of the light emitted by the illumination system,

the optical element being switchable in a mode of operation reducing the effect of the light-dispersing structure.

A light beam emitted by the light emitters travels via the light-collimator and the translucent cover plate and then passes through the switchable optical element and the light-dispersing structure. The optical effect of the light-dispersing structure, i.e. the broadening of the angular distribution, is caused by a change in refractive index at the interface of the light-dispersing structure and the switchable optical element. The switchable optical element is based on electrowetting. Electrowetting is the phenomenon whereby an electric field modifies the wetting behavior of an electrically susceptible fluid in contact with a partially wetted (i.e. a contact angle larger than 0° in absence of a voltage) insulated electrode and in direct electrical contact with, or capacitively coupled to, a second electrode. If an electric field is applied by applying a voltage between the electrodes a surface energy gradient is created which can be used to manipulate a polar fluid to move towards the insulated electrode or to replace a first by a second fluid. A switchable optical element based on electrowetting allows fluids to be independently manipulated under direct electrical control without the use of pumps, valves or even fixed channels. When the switchable optical element is switched to the mode of operation in which the effect of the light-dispersing structure is reduced, the switchable optical element introduces a fluid at the interface of the light-dispersing structure and the switchable optical element to reduce the change in refractive index at the interface of the light-dispersing structure and the switchable optical element.

By reducing the change in refractive index at the interface of the light-dispersing structure and the switchable optical element, the broadening of the angular distribution of the light emitted by the illumination system is reduced. When the switchable optical element is not in the mode of operation in which the effect of the light-dispersing structure is reduced, the angular distribution of the light emitted by the illumination system is broadened as would normally be the case for the light-dispersing structure. The width of the light beam emitted by the illumination system can be varied by changing the difference in refractive indices between the light-dispersing structure and the switchable optical element.

By way of example, if a collimated light beam travels through the light-dispersing structure, the light dispersion being induced by a surface texture of the light dispersing structure, and the switchable optical element, and the difference (n₂−n₁) in refractive index n₂ of the fluid introduced in the switchable optical element being in the mode of operation reducing the effect of the light-dispersing structure and n₁ of the light dispersing structure, would be larger than the difference (n₃−n₁) in refractive index n₃ of the second fluid and n₁ of the light-dispersing structure, i.e. (n₂−n₁)>(n₃−n₁), then, according to Snell's law, or according to diffraction theory, the shape of the light beam emitted by the illumination system would be changed by the light-dispersing structure upon exchange of the fluids, i.e. a more diverging light beam would be emitted by the illumination system when in one mode of operation as when in the other mode of operation.

The measure according to the invention allows the angular distribution of the light beam emitted by the illumination system to be influenced by suitably switching the switchable optical element to influence the difference between the refractive index of the light-dispersing structure and the refractive index of the switchable optical element. In principle, either by applying segmentation in the switchable optical element and by independent addressing of these segments or by sufficiently fast sequential operation of the system in the two modes, it is possible to switch between various angles of the light beam emitted by the illumination system. By suitably adapting the difference between the refractive index of the light-dispersing structure and the second transparent element, the shape of a light beam emitted by the illumination system can be changed from, for instance, a “spot” light beam with a relatively narrow angular distribution to a “flood” light beam with a relatively broad angular distribution. A further advantage of the illumination system according to the invention is that the shape of the light beam and/or the beam pattern of the illumination system can be adjusted dynamically.

A preferred embodiment of the illumination system according to the invention is characterized in that the effect of the light-dispersing structure is substantially counteracted when the switchable optical element operates in the mode of operation reducing the effect of the light-dispersing structure. In this favorable embodiment, if a collimated light beam travels through the light-dispersing structure and the switchable optical element and the refractive index n₂ of the fluid introduced in the switchable optical element being in the mode of operation reducing the effect of the light-dispersing structure, is substantially the same as the refractive index n₁ of the light-dispersing structure, i.e. n₂=n₁, then the shape of the light beam emitted by the illumination system is not changed by the light-dispersing structure, i.e. a collimated light beam is emitted by the illumination system.

An optical element based on electrowetting can be realized in various manners. A preferred embodiment of the illumination system according to the invention is characterized in that the switchable optical element comprises a cavity between the light-collimator and the translucent cover plate in a plane normal to the longitudinal axis, the cavity being provided with means enabling exchange of a first fluid by a second fluid in the cavity when the optical element switches to the mode of operation reducing the effect of the light-dispersing structure. When the second fluid is in the cavity of the switchable optical element the change in refractive index at the interface of the light-dispersing structure and the switchable optical element is reduced whereby the broadening of the angular distribution of the light emitted by the illumination system is reduced. The means enabling exchange of the first fluid by the second fluid in the cavity encompass a configuration of electrowetting electrodes controlled by a voltage control system and a suitable (hydrophobic) fluid contact layer in the cavity. In addition, an insulating layer may be formed between the fluid contact layer and one of the electrowetting electrodes.

A manner to stimulate the exchange of fluids in the cavity based on electrowetting is to give the fluids different electrical properties. To this end a preferred embodiment of the illumination system according to the invention is characterized in that the first fluid is electrically insulative and the second fluid is electrically conductive. A suitable combination is a first fluid comprising an oil-based electrically insulative fluid, for example silicone oil and a second fluid comprising an aqueous electrically conductive fluid, for example salted water having a predetermined refractive index.

Preferably, the first fluid is air and the second fluid is a polar liquid. Air is an electrically insulative fluid. A suitable example of a polar fluid is an aqueous electrically conductive fluid, for example salted water having a predetermined refractive index.

There are many embodiments to realize the light-dispersing structure. According to a preferred embodiment of the illumination system the light-dispersing structure comprises a lens, an array of micro-lenses or Fresnel-lenses or a diffractive optical element. In all cases, the surface texture causes a change in the beam shape in response to a difference in the refractive index between the materials forming the textured interface.

According to an alternative, preferred embodiment of the illumination system the light-dispersing structure comprises a holographic diffuser. Preferably, the holographic diffuser is a randomized holographic diffuser. The primary effect is a change in the beam shape. A secondary effect of the holographic diffuser is that a uniform spatial and angular color and light distribution is obtained. By the nature of the holographic diffuser, the dimensions of the holographic diffuser, or beam shaper, are so small that no details are projected on a target, thus resulting in a spatially and/or angularly smoothly varying, homogeneous beam pattern. When the switchable optical element is not in the mode of operation in which the effect of the light-dispersing structure is reduced, the angular distribution of the light emitted by the illumination system is broadened as would normally be the case for a holographic diffuser.

Light can propagate in various manners in the light-collimator. A preferred embodiment of the illumination system according to the invention is characterized in that light propagation in the light-collimator is based on total internal reflection or on reflection on reflective surfaces of the light-collimator. By basing the propagation of light emitted by the light emitters on total internal reflection (TIR), light losses in the light-collimator are largely avoided. In such an embodiment, the light-collimator is, preferably, made of a non-gaseous, optically transparent dielectric material with a refractive index larger than or equal to 1.3. In another embodiment, the dielectriclight-collimator is at least partly provided with a reflective coating on its outer surface. In yet another embodiment, (internal) surfaces of the light-collimators are provided with a reflective material. In such an embodiment, the light-collimator is, preferably, filled with air.

It may be desired to further stimulate light mixing in the illumination system or to further shape the light beam. The latter may apply to the non-dispersed light as well as to the dispersed light, or it may apply only to the dispersed light. To this end a preferred embodiment of the illumination system according to the invention is characterized in that the translucent cover plate at a side facing away from the light-emitters is provided with a reflector. Preferably, the reflector comprises a plurality of (substantially flat) side-faces arranged parallel to the longitudinal axis, spatial mixing of the light emitted by the light emitters is stimulated. If the reflector is provided with a substantially circular outer surface, this would be unfavorable for the spatial mixing of the light emitted by the light emitters. Preferably, the reflector is provided with at least six side-faces. It was found that such a preferred number of side-faces stimulates spatial and spatio-angular mixing of the light emitted by the light emitters.

These and other aspects of the invention are apparent from and will be elucidated with reference to the embodiments described hereinafter.

In the drawings:

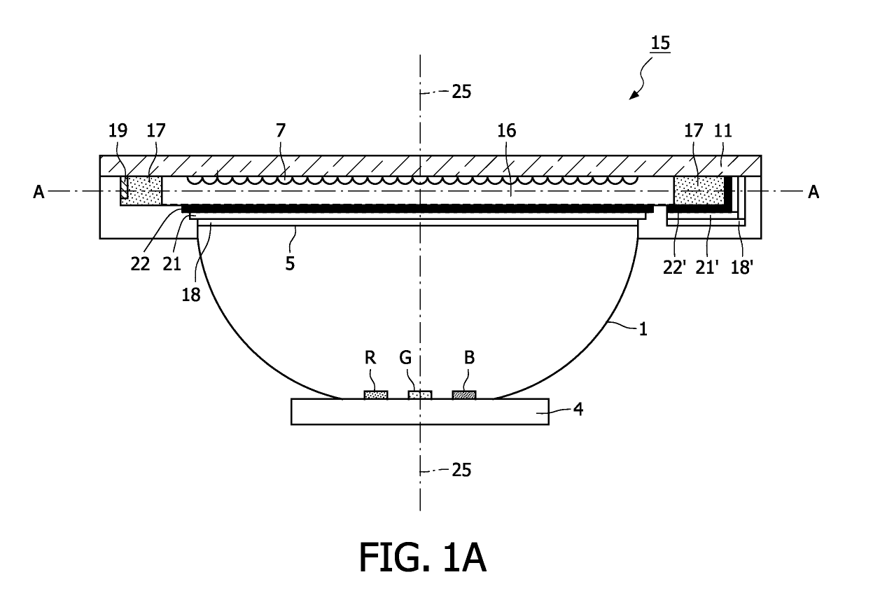

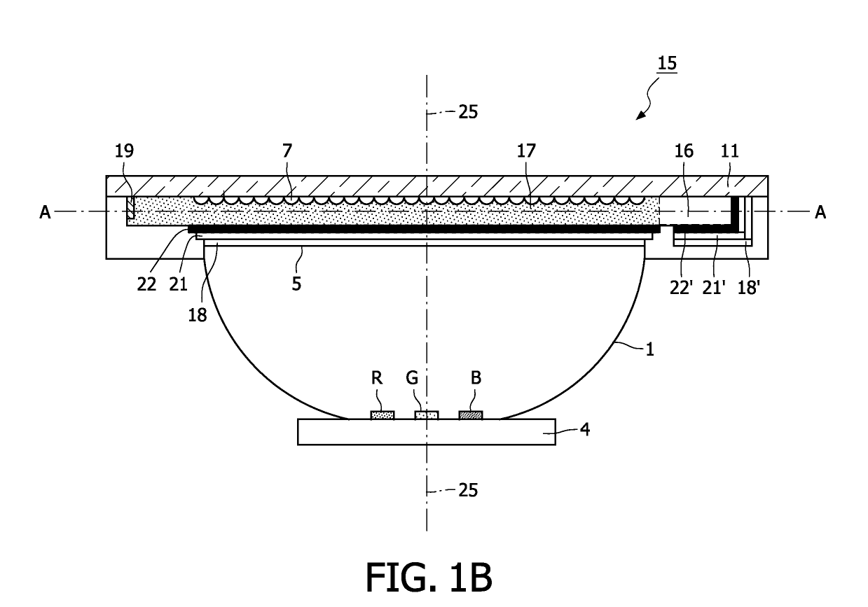

FIG. 1A is a cross-sectional view of a first embodiment of the illumination system according to the invention;

FIG. 1B is the embodiment of the illumination system shown in FIG. 1A in another mode of operation;

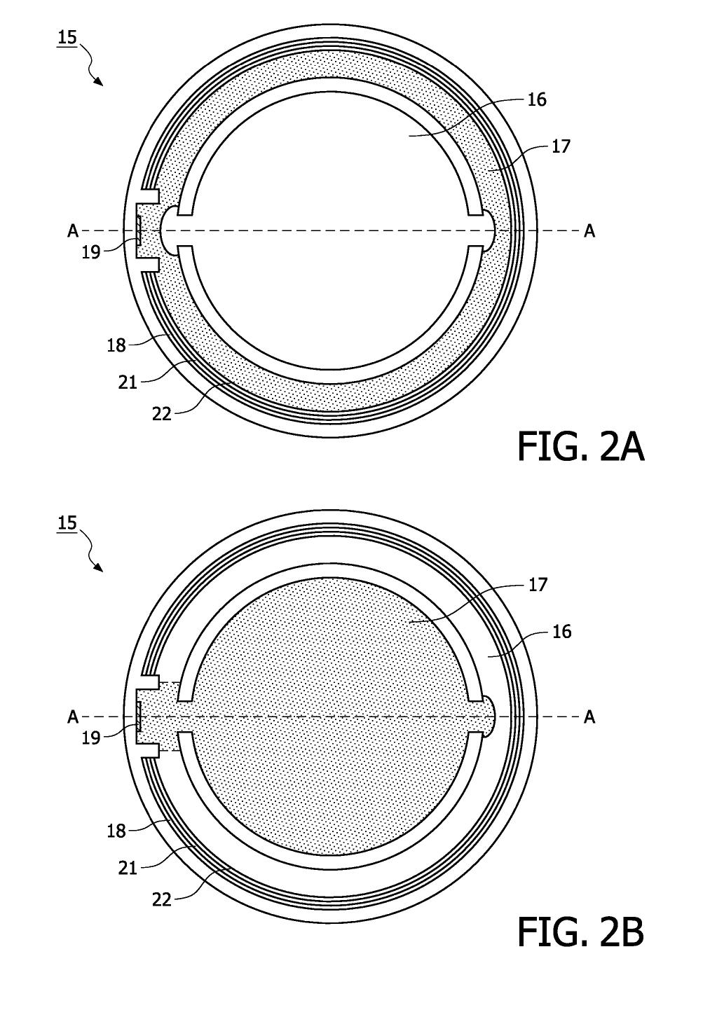

FIG. 2A is a cross-sectional view perpendicular to the view (line A-A) of the embodiment shown in FIG. 1A;

FIG. 2B is a cross-sectional view perpendicular to the view (line A-A) of the embodiment shown in FIG. 1B;

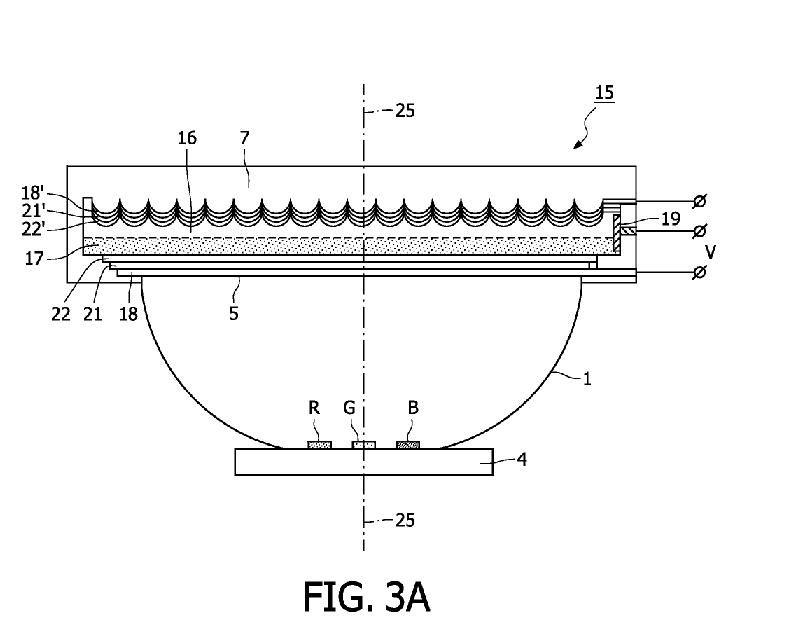

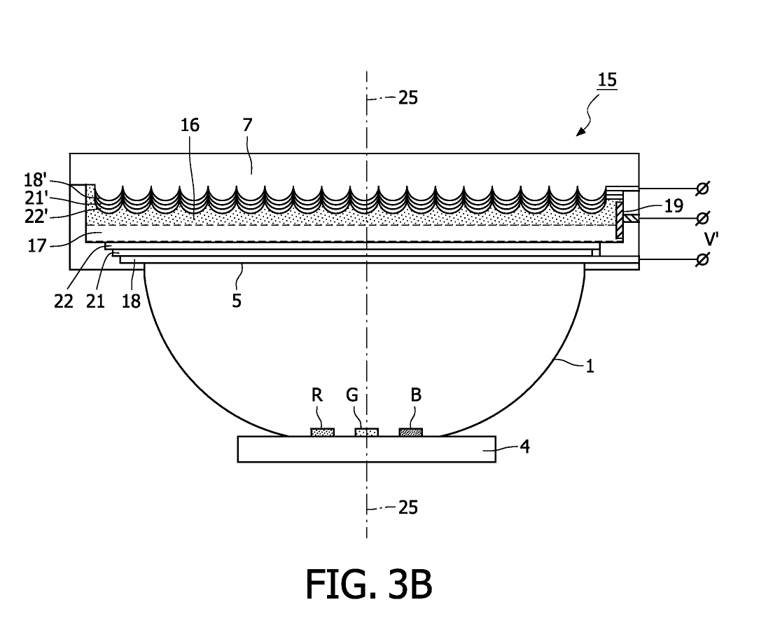

FIG. 3 A is a cross-sectional view of a second embodiment of the illumination system according to the invention;

FIG. 3B is the embodiment of the illumination system shown in FIG. 3A in another mode of operation;

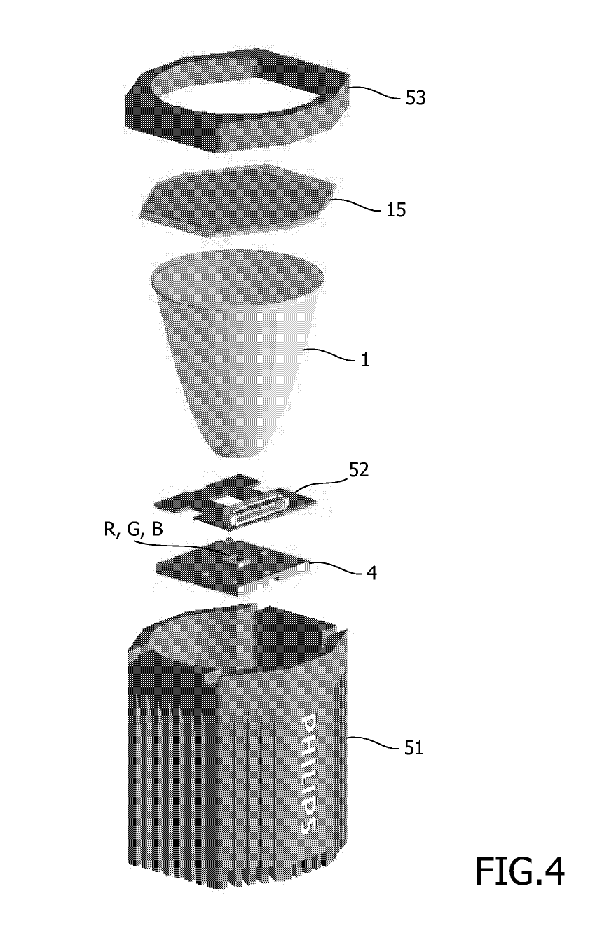

FIG. 4 is an exploded view of a further embodiment of the illumination system according to the invention;

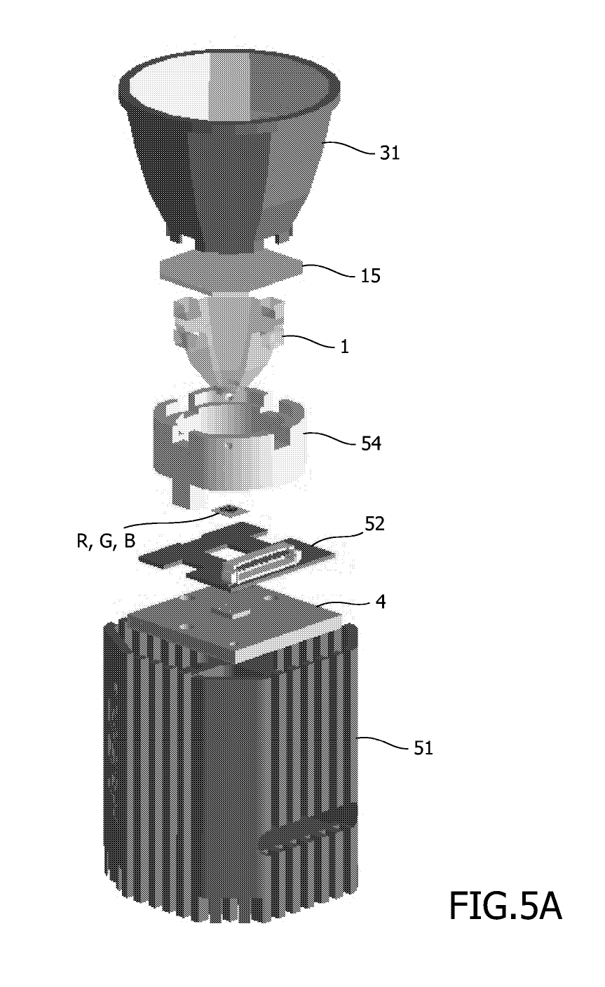

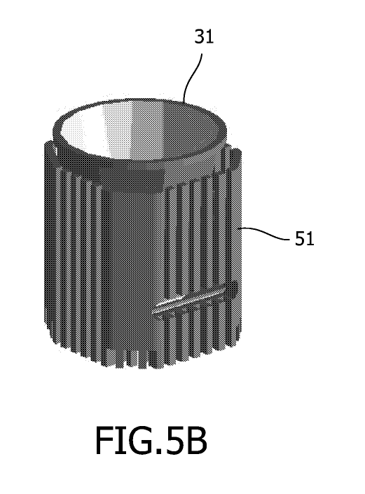

FIG. 5A is an exploded view of a further embodiment of the illumination system according to the invention, and

FIG. 5B is the embodiment of the illumination system of FIG. 5A in assembled form.

The Figures are purely diagrammatic and not drawn to scale. Notably, some dimensions are shown in a strongly exaggerated form for the sake of clarity. Similar components in the Figures are denoted as much as possible by the same reference numerals.

FIG. 1A schematically shows a cross-sectional view of a first embodiment of the illumination system according to the invention with an active light-dispersing structure. FIG. 1B schematically shows a cross-sectional view of the embodiment of the illumination system shown in FIG. 1A in the mode of operation where the effect of the light-dispersing structure is reduced.

The illumination system in FIGS. 1A and 1B comprises a plurality of light sources, for instance a plurality of light-emitting diodes (LEDs). LEDs can be light sources of distinct primary colors, such as in the example of FIGS. 1A and 1B, the well-known red R, green G, or blue B light emitters. Alternatively, the light emitter can have, for example, amber or cyan as primary color. The primary colors may be either generated directly by the light-emitting-diode chip, or may be generated by a phosphor upon irradiance with light from the light-emitting-diode chip. In the latter case, also mixed colors or white light can act as one of the primary colors of the illumination system. In the example of FIGS. 1A and 1B, the LEDs R, G, B are mounted on a (metal-core) printed circuit board 4. In general, the LEDs have a relatively high source brightness. Preferably, each of the LEDs has a radiant power output of at least 25 mW when driven at nominal power. LEDs having such a high output are also referred to as LED power packages. The use of such high-efficiency, high-output LEDs has the specific advantage that, at a desired, comparatively high light output, the number of LEDs may be comparatively small. This has a positive effect on the compactness and the efficiency of the illumination system to be manufactured. If LED power packages are mounted on such a (metal-core) printed circuit board 4, the heat generated by the LEDs can be readily dissipated by heat conduction via the PCB. In a favorable embodiment of the illumination system, the (metal-core) printed circuit board 4 is in contact with the housing (not shown in FIGS. 1A and 1B) of the illumination system via a heat-conducting connection. Preferably, so-called naked-power LED chips are mounted on a substrate, such as for instance an insulated metal substrate, a silicon substrate, a ceramic or a composite substrate. The substrate provides electrical connection to the chip and acts as well as a good heat transfer to a heat exchanger.

The embodiment of the illumination system as shown in FIGS. 1A and 1B comprises a light-collimator 1 for collimating light emitted by the light emitters R, G, B. The light-collimator 1 is arranged around a longitudinal axis 25 of the illumination system. A light-exit window 5 of the light-collimator 1 at a side facing away from the light-emitters R, G, B is provided with a translucent cover plate 11 provided with a switchable optical element 15. The switchable optical element is based on electrowetting. Electrowetting is the phenomenon whereby an electric field modifies the wetting behavior of a polar fluid in contact with a hydrophobic insulated electrode and in direct electrical contact with a second electrode. If an electric field is applied by applying a voltage between the electrodes a surface energy gradient is created which can be used to manipulate a polar fluid to move towards the insulated electrode or to replace a first by a second fluid. A switchable optical element based on electrowetting allows fluids to be independently manipulated under direct electrical control without the use of pumps, valves or even fixed channels.

In the example of FIGS. 1A and 1B, the translucent cover plate 11 is provided with a light-dispersing structure 7 for broadening an angular distribution of the light emitted by the illumination system. In an alternative embodiment, the light-exit window of the light-collimator is provided with a light-dispersing structure. According to the invention, the optical element 15 is switchable in a mode of operation reducing the effect of the light-dispersing structure 7.

The difference between FIGS. 1A and 1B is that the mode of operation is changed. In particular, FIG. 1A shows the situation where the switchable optical element 15 is not operating in the mode of operation reducing the effect of the light-dispersing structure while FIG. 1B shows the situation where the switchable optical element operates in the mode of operation reducing the effect of the light-dispersing structure.

The optical effect of the light-dispersing structure 7 is caused by a change in refractive index at the interface of the light-dispersing structure 7 and the fluid 16 or 17 in the switchable optical element 15. When the switchable optical element 15 is in the mode of operation in which the effect of the light-dispersing structure is not reduced (FIG. 1A), a first fluid 16 is present in the switchable optical element and in contact with the light-dispersing structure 7. Preferably, the first fluid 16 is electrically insulative. Preferably, the first fluid 16 is air. Alternatively, the first fluid 16 is oil, for instance silicone oil, or an alkane, e.g. hexadecane. When the switchable optical element 15 is in the mode of operation in which the effect of the light-dispersing structure is reduced (FIG. 1B), the first fluid 16 in the switchable optical element 15 is replaced by a second fluid 17 in the switchable optical element 15 being in contact with the light-dispersing structure 7. Preferably, the first fluid 16 is electrically insulating. Preferably, the second fluid 17 is a polar liquid, for example salted water with a predetermined refractive index, e.g. potassium chloride dissolved in water.

When the first fluid 16 is present between the light-dispersing structure 7 and the switchable optical element 15 there is a maximum change in refractive index at the interface of the light-dispersing structure 7 and the switchable optical element 15 in the case that the first fluid 16 is air and the second fluid 17 is a water based medium. This step in refractive index causes a broadening of the angular distribution of the light emitted by the illumination system. On the other hand, if in this system the second fluid is introduced by the switchable optical element 15 between the light-dispersing structure 7 and the switchable optical element 15 the change in refractive index at the interface of the light-dispersing structure and the switchable optical element is reduced. By reducing the change in refractive index, the broadening of the angular distribution of the light emitted by the illumination system is reduced.

Preferably, the effect of the light-dispersing structure 7 is substantially counteracted when the switchable optical element 15 operates in the mode of operation reducing the effect of the light-dispersing structure 7. Preferably, the refractive index of the second fluid 17 introduced in the switchable optical element 15 is substantially the same as the refractive index n₁ of the light-dispersing structure 7. In case the second fluid acts as a index-matching liquid for the light-dispersing structure 7, the light passing through the switchable optical element does not experience gradients in the refractive index and accordingly does not change direction of propagation. In this situation, the effect of the light-dispersing structure 7 is completely counterbalanced by the switchable optical element 15. In this situation, a collimated light beam is emitted by the illumination system, the collimating characteristics being substantially the same as the effect of the light-collimator or substantially the same as the effect of the light-collimator and additional beam-shaping optics in absence of the switchable optical element and the light dispersing structure.

The effect of altering the effective refractive index difference between the light-dispersing structure 7 and the fluid of the switchable optical element 15 that it is in contact with is employed to vary the shape of the light beam emitted by the illumination system. By adapting via fluid exchange in the switchable optical element 15, the angular distribution of the light beam emitted by the illumination system is changed. In this manner it is possible to switch electrically between various angles of the light beam emitted by the illumination system. For instance, a “spot” light beam with an angular distribution of approximately 10° Full Width at Half Maximum (FWHM) can be converted into, for instance, a “flood” light beam with an angular distribution of approximately 30° FWHM. In principle, the change in the beam pattern can be done (quasi) continuously by sufficiently fast sequential operation of the system in the two different modes with variable relative luminous flux contributions, or by inducing light dispersion in addressable segments of the switchable optical element.

The switchable optical element 15 based on electrowetting as shown in FIGS. 1A and 1B comprises a first transparent electrode 18 adjacent the light-exit window 5 and a second electrode 18′ at an edge of the switchable optical element 15. This second electrode 18′ is provided outside the light path of the light emitted by the light-collimator 1. A first and a second transparent insulating layer 21, 21′ is provided on top of these first and second electrodes 18, 18′, respectively. In addition, transparent hydrophobic layers 22, 22′ are provided on top of the insulating layers 21, 21′, respectively. In addition, a counter electrode 19 is provided. Preferably, the first transparent electrode 18 comprises indium tin oxide (ITO). Preferably, the insulating layer 21 comprises parylene. Preferably, the hydrophobic layer 22 comprises Teflon™ AF1600 produced by DuPont™. A surface of the hydrophobic layer 22 is in contact with a cavity where either the first fluid 16 or the second fluid 17 is present. If no voltage is applied between the first electrode 18 and the counter electrode 19 and a voltage is applied between the second electrode 18′and the counter electrode 19 (FIG. 1A), the first fluid 16, in this case the insulative fluid, for instance air, is between the light-dispersing structure 7 and the switchable optical element 15. If a voltage is applied between the first electrode 18 and the counter electrode 19 and no voltage is applied between the second electrode 18′ and the counter electrode 19 (FIG. 1B), the second fluid 17, in this case the electrically conductive fluid, for instance salted water, is between the light-dispersing structure 7 and the switchable optical element 15. In the latter configuration the effect of the light-dispersing structure is reduced, preferably, counterbalanced.

FIG. 2A schematically shows a cross-sectional view perpendicular to the view of the embodiment shown in FIG. 1A along the line A-A. Correspondingly, FIG. 2B schematically shows a cross-sectional view perpendicular to the view of the embodiment shown in FIG. 1B along the line A-A. When the switchable optical element 15 is in the mode of operation in which the effect of the light-dispersing structure is not reduced or counterbalanced (FIG. 2A), the first fluid 16 is present between the light-dispersing structure 7 and the switchable optical element 15. When the switchable optical element 15 is in the mode of operation in which the effect of the light-dispersing structure is reduced (FIG. 2B), the first fluid 16 in the switchable optical element 15 is replaced by the second fluid 17 between the light-dispersing structure 7 and the switchable optical element 15.

FIG. 3A schematically shows a cross-sectional view of a second embodiment of the illumination system according to the invention. FIG. 3B schematically shows the embodiment of the illumination system shown in FIG. 3A in another mode of operation. In the embodiment shown in FIGS. 3A and 3B the first fluid 16 and the second fluid 17 are always present between the light-exit window 5 of the light-collimator 1 and the light-dispersing structure 7. In this embodiment, the switchable optical element 15 causes a change in the location of the first and second fluid with respect to each other.

The switchable optical element 15 based on electrowetting as shown in FIGS. 3A and 3B comprises a first transparent electrode 18 adjacent the light-exit window 5 and a second transparent electrode 18′ adjacent the light-dispersing structure 7. A first and second transparent insulating layers 21, 21′ are provided on top of these first and second electrodes 18, 18′, respectively. Transparent hydrophobic layers 22, 22′ are provided on top of the insulating layers 21, 21′, respectively. In addition, a counter electrode 19 is provided. Preferably, the transparent electrodes 18, 18′ comprise indium tin oxide (ITO). Preferably, the insulating layers 21, 21′ comprise parylene. Preferably, the hydrophobic layers 22 comprise Teflon™ AF1600 produced by DuPont™. Opposing surfaces of the hydrophobic layers 22, 22′ are in contact with a cavity where either the first fluid 16 or the second fluid 17 is present. If a voltage V is applied between the first electrode 18 and the counter electrode 19 (FIG. 3A), the first fluid 16, in this case the insulative fluid, for instance air, is in contact with the light-dispersing structure 7 while the second fluid 17, in this case the conductive fluid, for instance salted water, is not in contact with the light-dispersing structure 7.

If a voltage is applied between the second electrode 18′ and the counter electrode 19 (FIG. 3B), the second fluid 17, in this case the conductive fluid, for instance salted water, is in contact with the light-dispersing structure 7 while the first fluid 16, in this case the insulative fluid, for instance air, is not in contact with the light-dispersing structure 7. In the latter configuration the effect of the light-dispersing structure is reduced, preferably, counterbalanced.

FIG. 4 schematically shows an exploded view of a further embodiment of the illumination system according to the invention. The illumination system comprises a housing 51 and LEDs R, G, B mounted on a (metal-core) printed circuit board 4. In addition, an interface board 52 with electrical connections means, thermal sensors etc. and a light-collimator 1 are provided. The switchable optical element 15 is attached to the light-collimator by a support means 53.

FIG. 5A schematically shows an exploded view of a further embodiment of the illumination system according to the invention. FIG. 5B shows the embodiment of the illumination system of FIG. 5A in assembled form. The illumination system comprises a housing 51 and LEDs R, G, B mounted on a (metal-core) printed circuit board 4. In addition, an interface board 52 with electrical connections means, thermal sensors etc. and a light-collimator 1 are provided. The light-collimator 1 is facetted to stimulate color mixing. A support means 54 accommodates the light-collimator 1. In addition, the illumination system is provided with a reflector 31 at a side facing away from the light-emitters R, G, B. The reflector 31 is facetted to further homogenize the light beam emitted by the illumination system.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An illumination system comprising:
a plurality of light emitters,
a light-collimator for collimating light emitted by the light emitters,
the light-collimator being arranged around a longitudinal axis of the illumination system,
a light-exit window of the light-collimator at a side facing away from the light-emitters being provided with a translucent cover plate provided with a switchable optical element based on electrowetting,
the light-exit window of the light-collimator or the translucent cover plate being provided with a light-dispersing structure for broadening an angular distribution of the light emitted by the illumination system,
the optical element being switchable in a mode of operation reducing the effect of the light-dispersing structure.

2. An illumination system as claimed in claim 1, wherein the effect of the light-dispersing structure is substantially counteracted when the switchable optical element operates in the mode of operation reducing the effect of the light-dispersing structure.

3. An illumination system as claimed in claim 1, wherein the switchable optical element comprises a cavity between the light-collimator and the translucent cover plate in a plane normal to the longitudinal axis, the cavity being provided with means enabling exchange of a first fluid by a second fluid in the cavity when the optical element switches to the mode of operation reducing the effect of the light-dispersing structure.

4. An illumination system as claimed in claim 3, wherein the switchable optical element is in optical contact with the light-collimator, the light-collimator being filled with a dielectric material with a refractive index larger than 1.3.

5. An illumination system as claimed in claim 3, wherein the first fluid is electrically insulative and the second fluid is electrically conductive.

6. An illumination system as claimed in claim 5, wherein the first fluid is air or oil and the second fluid is a polar liquid.

7. An illumination system as claimed in claim 1, wherein the light-dispersing structure comprises a lens, an array of lenses or a diffractive optical element.

8. An illumination system as claimed in claim 7, wherein the diffractive optical element comprises a holographic diffuser.

9. An illumination system as claimed in claim 1, wherein light propagation in the light-collimator is based on total internal reflection or on reflection on reflective surfaces of the light-collimator.

10. An illumination system as claimed in claim 9, wherein the light-collimator comprises a non-gaseous dielectric material.

11. An illumination system as claimed in claim 1, wherein the translucent cover plate at a side facing away from the light-emitters (R, G, B) is provided with a reflector.

12. An illumination system as claimed in claim 1, wherein the illumination system comprises a plurality of light-emitting diodes of distinct primary colors or of a single primary color.

13. An illumination system as claimed in claim 11, wherein each of the LEDs has a radiant power output of at least 25 mW when driven at nominal power.
